(19) United States
(12) Patent Application Publication
(10) Pub. No.: US 2014/0350980 A1
(43) Pub. Date: Nov. 27, 2014

(54) GEOGRAPHIC MOBILE CUSTOMER RELATIONS MANAGEMENT

(71) Applicant: Badger Mapping Solutions LLC, San Francisco, CA (US)

(72) Inventor: Aaron Tolson, San Francisco, CA (US)

(21) Appl. No.: 14/263,998

(22) Filed: Apr. 28, 2014

Related U.S. Application Data
(60) Provisional application No. 61/816,617, filed on Apr. 26, 2013.

(51) Int. Cl. G06Q 30/00; H04L 29/06; H04L 29/08

(52) U.S. Cl. CPC G06Q 30/01; H04L 67/10; H04L 67/42
USPC 705/7.11

(57) ABSTRACT

A system for geographic mobile customer relations management, comprising a database that stores CRM data, a tile server that provides discrete portions of CRM data, an object relational mapping server that associates location-based information with CRM data, and an interface that provides the CRM data to external applications.

### CROSS-REFERENCE TO RELATED APPLICATIONS

This application claims the benefit of, and priority to, U.S. provisional patent application Ser. No. 61/816,617, titled “GEOGRAPHIC MOBILE CUSTOMER RELATIONS MANAGEMENT” filed on Apr. 26, 2013, the entire specification of which is incorporated herein by reference.

### BACKGROUND OF THE INVENTION

1. Field of the Invention

The invention relates to the field of customer relations management, and more particularly to the field of mobile software for customer relations management.

2. Discussion of the State of the Art

In the field of customer relations management (CRM), there exists a class of salesperson that tends to spend a large amount of time in the field, interacting with potentially hundreds of accounts per day spread across a geographic territory. The most appropriate method for such a salesperson to consume or interact with CRM data would be in a geographic context. Additionally, according to an IDC survey 59% of companies are planning to increase focused spending on mobile technologies, with mobile CRM solutions being a dominant focus.

A mobile salesperson may encounter challenges such as a lack of solutions for intuitive, easy to use CRM access in the field, or too many accounts to track on a traditional spreadsheet or similar format while driving, causing a loss of productivity or missed sales.

What is needed, is a mobile solution for viewing or interacting with CRM data in a geographic context, that is easy to use and intuitive for salesperson use regardless of technological ability and with minimal up-training required for adoption.

### SUMMARY OF THE INVENTION

Accordingly, the inventor has conceived and reduced to practice, in a preferred embodiment of the invention, a system for geographic mobile CRM data interaction.

According to a preferred embodiment of the invention, a system for geographic mobile CRM data interaction comprising a CRM server that may manage CRM features and operations, a database that may store CRM information such as customer accounts, an application server that may operate software means for interaction with a CRM server, and a web server that may provide network-accessible means for user interaction, is disclosed. According to the embodiment, an application server may provide interactive means such as a webpage or web-enabled software application, for example a mobile application operating on a user's mobile device (such as a smartphone, tablet computing device, or other appropriate electronic device for interaction). Such means may be accessible via web interaction, for example via a network-connected device (such as exemplary mobile devices described above), or via an Internet browser or other network interaction means, and such interaction may be facilitated by a web server.

According to the embodiment, such a system may be employed for such purposes as to enable mobile CRM management and interaction such as by a user on a mobile device, for example a mobile sales associate using a smartphone while in the field to manage customer account information. In this manner, it becomes possible for CRM operation to take place as needed, such as when a customer makes a change or request, rather than having to be delegated for later handling by a CRM associate using a traditional CRM management means, such as is common in the art. For example, as envisioned by the inventor, a mobile software application may be utilized to provide a user-friendly and functional graphical user interface (GUI) for interaction with CRM information, via interaction with the components of a mobile CRM system as described herein. In this manner, CRM management may be facilitated in a user-friendly manner with minimal learning curve and maximized functionality, while incorporating existing CRM components that may already be in use (such as a pre-existing CRM database), by extending existing functionality through the addition of system components describe herein to facilitate mobile management.

According to the embodiment, a mobile CRM management system may comprise a tile server that may provide discrete portions of data to expedite operation and interaction (such as may be necessary for use on mobile devices or in other situation where computing resources may limit the ability to render large amounts of data simultaneously), and an object relational mapping (ORM) server that may facilitate association of data with locational information such as geographic information (for example, a user's physical location or address). According to the embodiment, by utilizing geographical information such as might be obtained from a user device (for example, a mobile smartphone or tablet computing device that may ordinarily provide location data on request), it becomes possible to associate this geographical information with CRM data such as user account information, for such purposes as to (for example) provide a location-based view of customer information such as concentrations of existing customers or locations of potential future customers, or to provide this location-enabled information for further processing such as to determine areas where new customers are likely or areas where existing customers may be more receptive to additional sales (or any other such CRM-focused use that may be enhanced through utilization of geographic or other location-based information).

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is a block diagram illustrating an exemplary system architecture for mobile CRM, according to a preferred embodiment of the invention.

FIG. 5 is a block diagram illustrating a more detailed exemplary system architecture for mobile CRM, according to a preferred embodiment of the invention.

FIG. 6 is another block diagram illustrating an exemplary hardware architecture of a computing device used in various embodiments of the invention.

FIG. 7 is a method flow diagram illustrating an exemplary method for mobile CRM, according to an embodiment of the invention.

### DETAILED DESCRIPTION

The inventor has conceived, and reduced to practice, a system for mobile CRM interaction in a geographic context.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

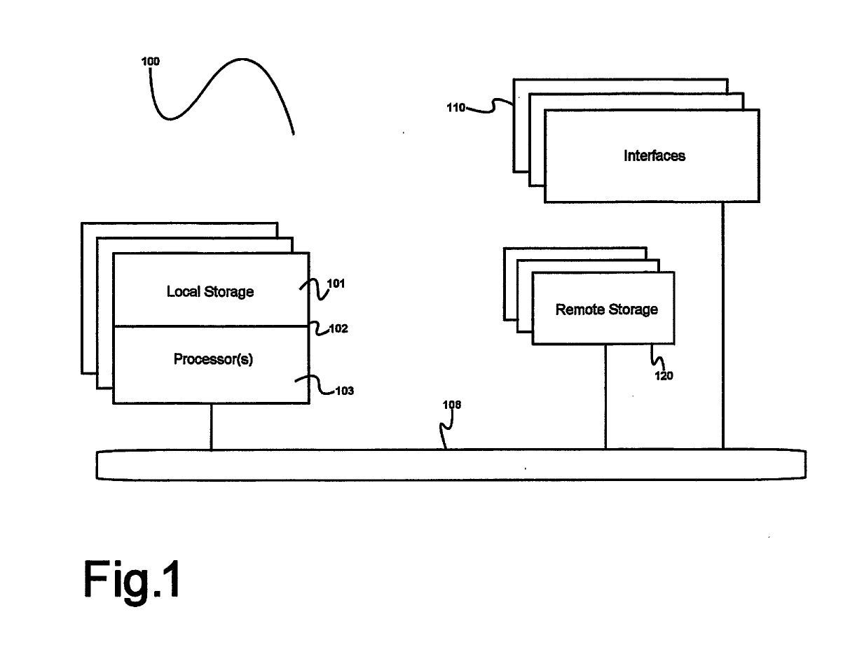

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

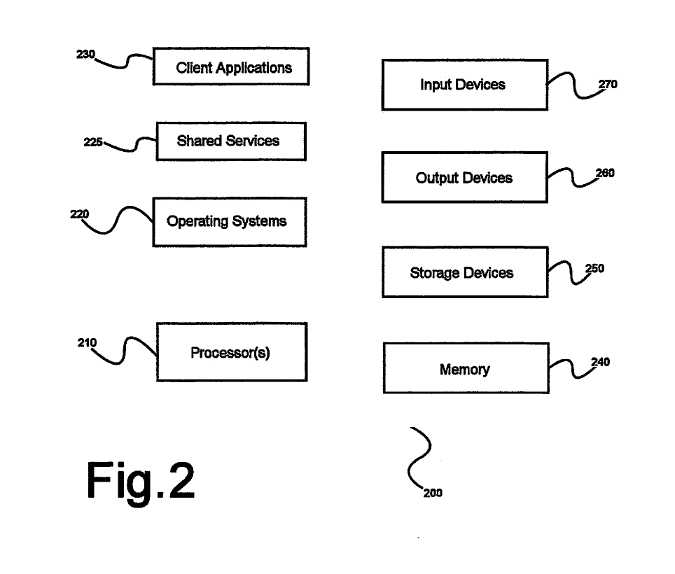

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

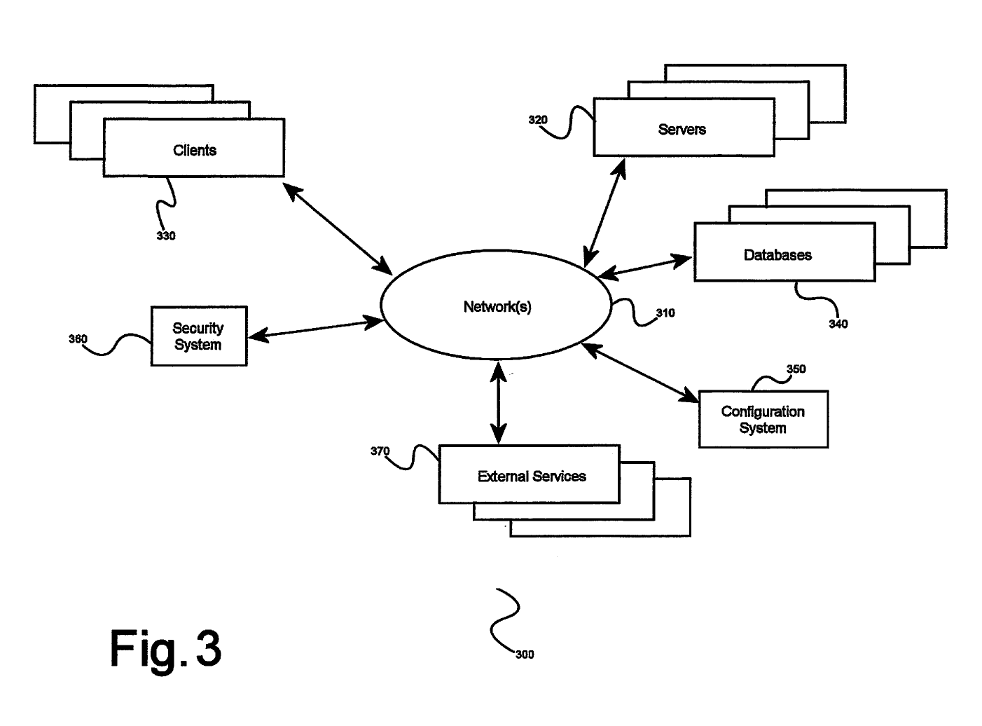

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

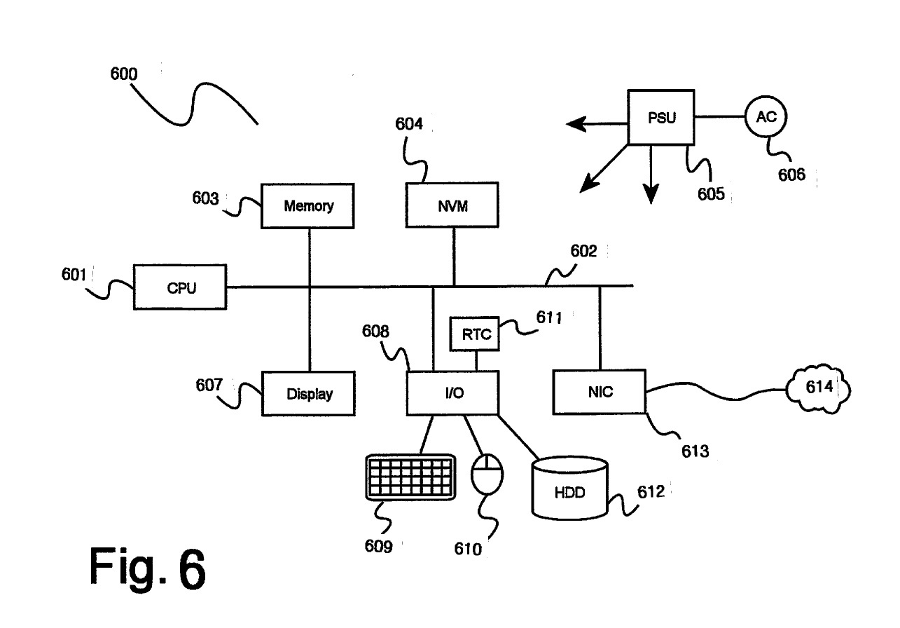

FIG. 6 shows an exemplary overview of a computer system 600 as may be used in any of the various locations throughout the system. It is exemplary of any computer that may execute code to process data. Various modifications and changes may be made to computer system 600 without departing from the broader scope of the system and method disclosed herein. CPU 601 is connected to bus 602, to which bus is also connected memory 603, nonvolatile memory 604, display 607, I/O unit 608, and network interface card (NIC) 613. I/O unit 608 may, typically, be connected to keyboard 609, pointing device 610, hard disk 612, and real-time clock 611. NIC 613 connects to network 614, which may be the Internet or a local network, which local network may or may not have connections to the Internet. Also shown as part of system 600 is power supply unit 605 connected, in this example, to ac supply 606. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

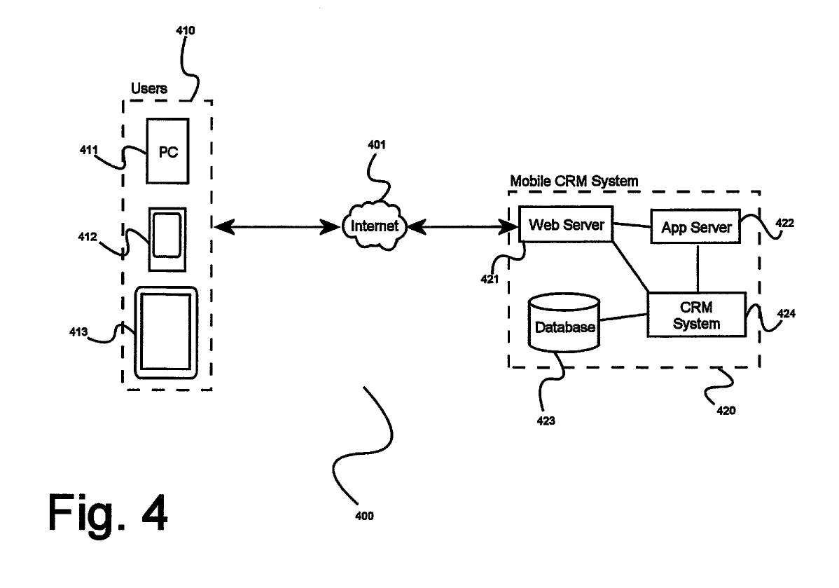

FIG. 4 is an illustration of an exemplary system 400 for operating mobile CRM data for interaction such as by a mobile salesperson or other user 410, according to a preferred embodiment of the invention. As illustrated, various traditional components of a computing network may be interconnected and in communication via the Internet 401 or a similar data communications network. It should be appreciated by one having ordinary skill in the art, that such an arrangement is exemplary and a variety of connection and communication means exist which may be utilized according to the invention, and it should be further appreciated that various combinations of connections and communication means may be utilized.

As illustrated, a plurality of users 410 may interact with a mobile CRM system 420 via a variety of hardware or software means common in the art, several examples of which are illustrated. It should be appreciated that such means as illustrated and described below are exemplary, and any of a variety of additional or alternate means may be utilized according to the invention. Hardware means may include (but are not limited to) electronic devices capable of communication over a network 401, such as a personal computer 411 (such as a laptop or desktop computer), mobile smartphone 412, or a tablet computing device 413. As appropriate and according to the specific nature of a device being utilized, users 410 may interact using a variety of software means (not illustrated), such as a web browser accessing a webpage or other internet-enabled software (as may be appropriate when using a personal computer 411), or a mobile application (as may be appropriate when using a mobile smartphone 412 or tablet computing device 413). It should be appreciated that, as with physical devices described above, such means as described are exemplary and a variety of additional or alternate means may be utilized according to the invention.

As further illustrated, users 410 may communicate across a network 401 or similar communication connection, for such purposes as interaction with a social media management system 420, various components of which may be similarly connected to a network 401 for communication, and which may also be interconnected within system 420 for communication with other components. Such components may include (but are not limited to) a web server 421 that may operate web-accessible content such as webpages or interfaces for viewing by users and also may receive web interactions from users, an application server 422 that may operate various software elements for interaction such as via web-enabled means operated by web server 421, a database 423 or similar data storage component that may store data from other components as well as provide such stored data for interaction (such as for viewing or modifying existing data), and a CRM service 424 that may operate software components facilitating management of social media content or accounts.

As illustrated, CRM service 424 may be connected and in communication with other components such as app server 422 such as to provide functionality for interaction via software elements (as may be appropriate for incorporating social media management functionality in other software elements, as described in greater detail below), web server 421 such as to provide functionality for interaction via webpages or similar web-enabled means, and database 423 such as to store and retrieve information relevant to agreement management. In this manner it can be appreciated that a function of CRM service 424 may be to provide functionality to other components that may operate specific means of interaction, while still optionally providing functionality directly to user applications or devices 410, thereby enabling a variety of arrangements and means of interaction according to the invention.

### Detailed Description of Exemplary Embodiments

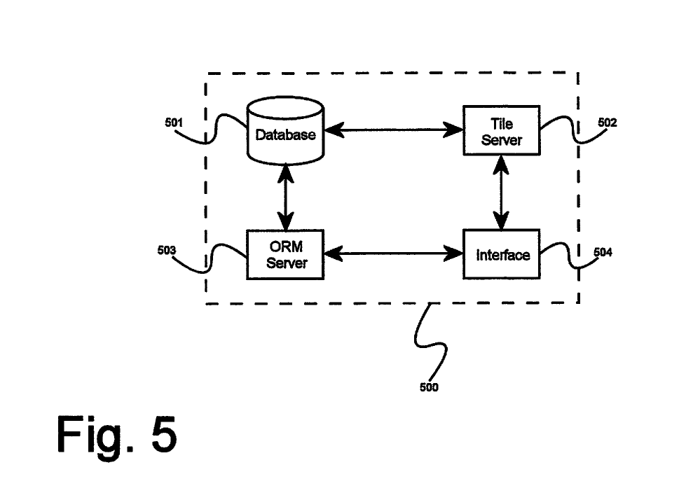

FIG. 5 is a more detailed illustration of an exemplary system 500 for providing mobile CRM functionality, such as might be utilized as a CRM Service 424 as described above (referring to FIG. 4), according to a preferred embodiment of the invention. As illustrated, internal components of system 500 may be interconnected such as for communication between components, and it should be appreciated that additional or alternate connections or components may be utilized according to the invention, those illustrated being exemplary for illustration of basic function of system 500.

As illustrated, a database 501 may be utilized for such purposes as to store and serve CRM data or other potentially-relevant information such as geographic information (map images, logged GPS data, or other such location-based information) to other components of system 500 or to connected users. Database 501 may be of varied design and implementation, such as a physical datastore (such as a tape deck, optical disc, hard disk drive or other physical storage medium as are common in the art) or a software-based storage or organizational system such as a SQL-based database or cloud storage, or other software-based data storage format.

As further illustrated, a tile server 501 may be utilized for such purposes as serving “tiles” of information, essentially discrete portions of a whole, rather than serving large portions of information at a time, increasing efficiency by decreasing load and latency. Such functionality may be useful particularly for geographic data, such as loading small map tiles rather than a larger map view when only a portion is required—i.e., if a user requests the geographic view for a specific ZIP code or street, only the immediate area may be presented rather than (for example) loading the map data for an entire town.

As further illustrated, an object relational mapping (ORM) server 503 may be utilized, and may perform object-mapping tasks such as (for example) user authentication or mapping CRM data to geographic locations. It will be appreciated by one having ordinary skill in the art that a variety of object-mapping use cases are possible and may be utilized according to the invention.

As further illustrated, a user interface 504 may be utilized such as to allow a connected user to interact with various components of system 500 such as to view or interact with CRM data. Such an interface may be of varied nature according to the invention, but as envisioned by the inventor should be an adaptable software application programming interface (API) such that system 500 may be interfaced with a variety of end products or devices such as tablet computing devices or smartphones, and such that third-party or additional components may easily be integrated with system 500 such as to enhance function. In this manner, system 500 may be accessible to users regardless of their individual requirements, facilitating a more flexible design and improving user convenience and availability of content.

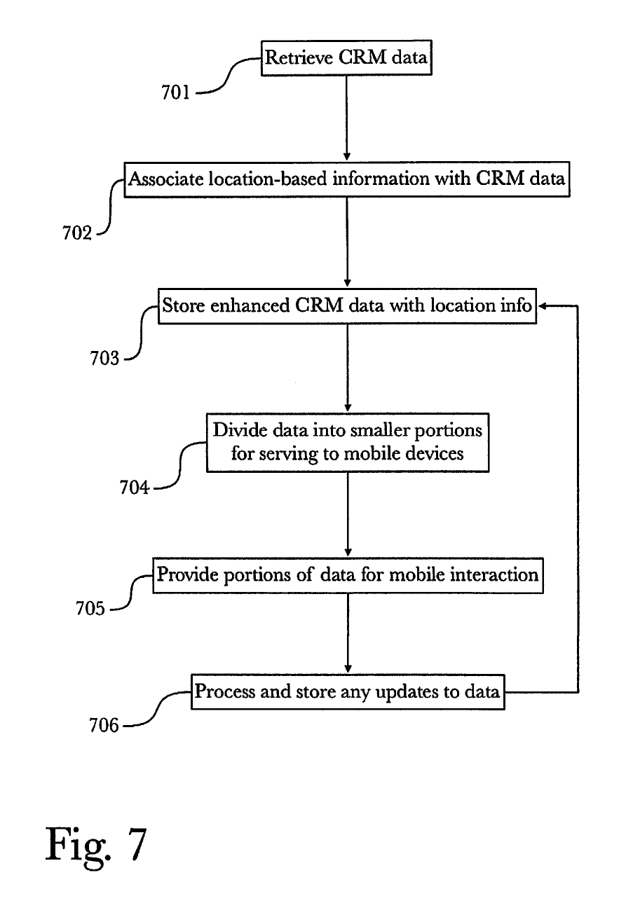

FIG. 7 is a method flow diagram illustrating an exemplary method 700 for providing mobile CRM, according to an embodiment of the invention. According to the embodiment, in an initial step 701 CRM data may be retrieved, such by a tile server form a database, such as to make it available for processing or interaction. In a next step 702, this CRM data may have location-based information (such as geographic information or other such information that may be considered relevant and useful to the CRM data or functions) associated with it, such as by an object relational mapping server as described above (referring to FIG. 4). In a next step 703 the newly-enhanced CRM data with location information may then be stored for future reference, such as to update previous CRM data now that location-based information has been associated with it (thus preventing the need to re-associate the location data each time the CRM data is loaded, by storing it with the CRM data such that the location-based information may be made available whenever the CRM data is retrieved). In a next step 704, the tile server may then divide the data into smaller portions, for example based on geographical location (such as displaying only a portion of a CRM database based on a small area of a map being viewed in a mobile CRM application, for example), as might be useful for viewing CRM data on devices with hardware limitations such as a mobile smartphone or other mobile or embedded computing device. In this manner, CRM data may be viewed and interacted with in a geographic context, regardless of the specific nature of the device being utilized for interaction as a tile server may accommodate the device's limitations by further dividing the CRM data such that manageable portions of the data are viewed individually rather than attempting to view “too much” data at one time. In a further step 705, the “tiles” or portions of data may be provided for user interaction, such as by making them available to external applications (for example, via an application programming interface or other software means), such that a user (for example, a mobile salesperson) may view and interact with the data as desired. In a final step 706, any new changes made may be stored for future use, such as if a mobile salesperson updates any CRM data (for example, managing a customer's account or making a sale, or any other such operation that might involve CRM data), optionally incorporating any new location-based information as appropriate (such as if a customer's geographic information is recorded or updated).

In this manner, it becomes possible for users such as salespersons (or any individual that might view or interact with CRM data, a salesperson is provided as a convenient example that is common in the art) to view, interact with, and manage CRM data while “in the field”, such as while traveling to make sales to new customers or to interact with current customers such as for account maintenance or other such purposes. CRM data may be enhanced with location-based data to increase utility to a user in the field, for example to enable viewing based on location-specific context such as “view all customers within x distance” or other such uses, for example. In this manner CRM operations may be improved by making the data both more useful and more available to users, and also by enabling users in the field to interact with the data immediately as needed (such as when a sale is made) rather than needing to perform updates later or delegate CRM operations to another individual (such as an account service associate in a contact center) that might have access to the data in a traditional context.

Additionally, it becomes possible to improve sales or other operations by incorporating routing behavior, such as determining an optimal sales route based on known geographic information in a CRM database. For example, a salesperson might be able to see where existing customers are located and plot a route with maximum probability of making new sales, either manually (such as by interaction with a map or similar location-based display with the CRM data) or in an automated or semi-automated manner (for example, by selecting from a list of automatically calculated routes based on the location-enhanced CRM data available).

The skilled person will be aware of a range of possible modifications of the various embodiments described above. Accordingly, the present invention is defined by the claims and their equivalents.

What is claimed is:

1. A system for mobile customer relations management (CRM), comprising:
an object relational mapping server stored and operating on a network-connected computing device;
a tile server stored and operating on a network-connected computing device;
an interface stored and operating on a network-connected computing device; and
a database stored and operating on a network-connected computing device.
wherein the object relational mapping server associates location information with customer relations management information;
wherein the tile server provides data portions of customer relations management information to an interface;
wherein the interface provides the data portions to a human user; and
wherein the database stores the data portions for future reference.

2. The system of claim 1, wherein the location information comprises at least geographical data.

3. The system of claim 1, wherein the interface is a graphical user interface.

4. The system of claim 1, wherein the interface is an application programming interface.

5. The system of claim 1, further comprising an application server stored and operating on a network-connected computing device, wherein the application server operates a software module for enabling a human user to interact with the customer relations management data.

6. The system of claim 5, further comprising a web server stored and operating on a network-connected computing device, wherein the web server facilitates network-based interaction with the software module.

7. A method for providing mobile customer relations management, comprising the steps of:
receiving, at a tile server software module stored and operating on a network-attached computer, customer relationship management (CRM) data;
enhancing, with an object relation mapping server software module stored and operating on a network-attached computer, the CRM data with location-based information;
providing, with the tile server software module, portions of the location-enhanced CRM data; and
storing, in a database stored and operating on a network-attached computer, the location-enhanced CRM data.

8. The method of claim 7, further comprising the step of providing the portions of location-enhanced CRM data via a software interface.

9. The method of claim 8, wherein the software interface is a software API.
